(19) United States
(12) Patent Application Publication
(10) Pub. No.: US 2024/0150566 A1
(43) Pub. Date: May 9, 2024

(54) HEAT-RESISTANT EPDM COMPOSITION, AND ASSOCIATED FORMULATION METHOD AND PARTS

(71) Applicant: AIRBOSS OF AMERICA CORP., Newmarket (CA)

(72) Inventors: Ali VAHIDIFAR, Newmarket (CA); Steven YU, Newmarket (CA)

(21) Appl. No.: 18/280,972

(22) PCT Filed: Mar. 8, 2022
(86) PCT No.: PCT/IB2022/000114

§ 371 Date: Sep. 8, 2023

Related U.S. Application Data
(60) Provisional application No. 63/157,995, filed on Mar. 8, 2021.

(51) Int. Cl. C08L 23/16; C08J 3/24; C08K 3/013; C08K 3/04; C08K 3/22; C08K 5/3447

(52) U.S. Cl. CPC C08L 23/16; C08J 3/24; C08K 3/013; C08K 3/04; C08K 3/22; C08K 5/3447; C08J 2323/16; C08K 2003/2296; C08L 2201/08; C08L 2205/025

(57) ABSTRACT

A rubber composition includes an ethylene-propylene-diene base terpolymer (EPDM) and exhibits advantageous aging properties in a high temperature environment. For example, it retains at least 30% of elongation at break and/or at least 70% tensile strength after heat aging at 350° F. for 504 hours; or it retains at least 50% of elongation at break and at least 70% tensile strength after heat aging at 392° F. for 70 hours. Such excellent heat aging performance has qualified HEATBOSS® EPDM for type E applications or basic F application per SAE J200 or ASTM D2000. The diene of the EPDM may be 5-vinylidene-2-norbornene (VNB), 5-methyl-ene-2-norbornene (MVNB), or another diene having a peroxide crosslinking efficiency (E) of at least 1.

This application claims the priority benefit of U.S. Provisional Application Ser. No. 63/157,995, filed Mar. 8, 2021, the contents of which are incorporated by reference herein.

### BACKGROUND

In modern cars, the space for the engine compartment is continuously shrinking for both functional and aesthetic reasons. Reducing the space available for design engineers results in hotter engine components which restricts the rubber materials that can be used. This has boosted a fast-growing demand in the rubber industry for elastomer parts with increased temperature extremes and durability. Among elastomers, silicone elastomers and fluoroelastomers exhibit effective heat resistance resulting from the strong Si—O and C—F bond present in their chemical structure. However, the main drawbacks are their high density, high price and high processing cost that makes compounding, molding, and final production very expensive. Ethylene-propylene-diene terpolymer (EPDM), as one of the lowest density elastomer, is one of the general-purpose, yet fast-growing synthetic elastomers. It has found a wide range of applications in automobile sectors thanks to its exceptional qualities, including decent thermal stability that can be attributed to its saturated main chain structure. Today, EPDM, in terms of sales volume, is the first elastomer, among non-tire elastomers. Although the mostly saturated backbone provides good resistance to oxidation, ozonation, and weathering, the capability of operating, for an extended service life, at high temperatures (above 320° F., for example) without losing functionality is still the most critical unmet need for EPDM systems. The progressive change in performance of elastomeric material, i.e., deterioration, under heat aging, can be represented by the occurrence of three typical types of reactions: heat-induced crosslinks, chain scission, and chemical structure alteration. It is well-documented that peroxide curing leads to improved performance, service life, and high-temperature resistance of EPDM as compared to sulfur curing. This can be attributed to the higher stability bond energy of C—C bonds (351 kJ/mol bond energy) formed by peroxide curing in comparison with C—S (285 kJ/mol) and polysulfide bonds (267 kJ/mol) formed by sulfur curing. With the aim of achieving high heat resistance, peroxide vulcanization has been used in this work. Multi-functional organic molecules, or named co-agents, are also added to boost peroxide vulcanization efficiency.

It would be desirable to develop new EPDM rubber compositions that exhibit high heat resistance and/or improved vulcanization efficiency.

### BRIEF DESCRIPTION

The present disclosure relates to a rubber composition including an ethylene-propylene-diene base terpolymer (EPDM) which exhibits advantageous aging properties in a high temperature environment.

Disclosed, in some embodiments, is a rubber composition containing an ethylene-propylene-diene base terpolymer (EPDM). The rubber composition retains at least 35% of elongation at break and/or at least 55% tensile strength after heat aging at 350° F. for 504 hours.

Disclosed, in some embodiments, is a rubber composition containing an ethylene-propylene-diene base terpolymer (EPDM). The rubber composition retains at least 70% of elongation at break and/or at least 50% tensile strength after heat aging at 392° F. for 70 hours to get the basic requirement of F1 spec.

A diene of the EPDM may be from the group consisting of 5-vinylidene-2-norbornene (VNB), 5-methylene-2-norbornene (MNB), 5-ethylidene-2-norbornene (ENB), 5-butyl-2-norbornene (BNB), 5-Crotyl-2-norbornene (CrNB), 5-Methallyl-2-norbornene (MANB), 5-isopropylidene-2-norbornene (IPNB), 5-Methyl-5-vinyl-2-norbornene (MeVNB), 5-Propenyl-2-norbornene (PNB), and a combination of any two or more thereof.

In some embodiments, the diene is present in the EPDM in an amount in the range of about 0 wt % to about 8 wt %. including about 0 wt % to about 4 wt % or about 0 wt % to about 2 wt %.

The ethylene content of the EPDM may be in the range of about 40 wt % to about 80 wt %, including about 50 wt % to about 70 wt % or about 55 wt % to about 65 wt %.

In some embodiments, a propylene content of the EPDM is in the range of about 25 wt % to about 50 wt %, including about 35 wt % to about 45 wt % or about 35 wt % to about 40 wt %.

The rubber composition may further include an oil. Non-limiting examples of oils include a paraffinic oil, a naphthenic oil, and a combination thereof.

In some embodiments, the paraffinic oil is a combination of one or more paraffinic oils having any viscosity between 20 cSt to 550 cSt according to ASTM D445 at 40° C.

The paraffinic oil may be present in the rubber composition in an amount of about 20 to about 120 parts per hundred parts EPDM (phr), including about 35 to about 65 phr.

In some embodiments, the rubber composition further includes a zinc salt internal lubricant. The zinc salt internal lubricant may be present in the rubber composition in an amount of about 5 to about 30 phr, including about 12 to about 18 phr.

The rubber composition may further include at least one filler which may be selected from the group consisting of carbon black, calcium carbonate, silica, clay, magnesium carbonate, magnesium silicate, mica, talc, graphite, and wollastonite.

In some embodiments, the filler is present in an amount of about 10 to about 100 phr, including about 30 to about 80 phr or about 40 to about 70 phr.

The filler may have an average particle size in the range of 10 nm to 500 nm.

In some embodiments, the rubber composition further includes a wax. The wax may be present in the rubber composition in an amount of about 1 to about 20 phr, including about 3 to about 7 phr.

The wax may include a paraffinic wax. In some embodiments, the paraffinic wax has a congealing point in the range of about 149 to about 156° F.

In some embodiments, the wax includes a low molecular weight polyethylene. The low molecular weight polyethylene may have a melting point in the range of about 100 to about 108° C.

The wax may contain a mixture of a paraffinic wax, microcrystalline wax, low molecular weight polyethylene and low molecular weight polypropylene.

In some embodiments, the rubber composition further contains a coagent. The coagent may present in the rubber composition in an amount of about 1 to about 20 phr, including about 3 to about 10 phr.

The coagent may include a monomethacrylate or its salt. Non-limiting examples include calcium methacrylate, zinc methacrylate, methyl methacrylate and butyl methacrylate. The monomethacrylate may have a molecular weight in the range of 150 g/mol to 189 g/mol.

In some embodiments, the coagent includes a methacrylate. The methacrylate may have a molecular weight in the range of 200 g/mol to 250 g/mol.

The coagent may include a mixture of a monomethacrylate or its salt and another methacrylate or its salt.

In some embodiments, the rubber composition includes an antioxidant. The antioxidant may be present in an amount of about 1 to about 10 phr, including about 3 to about 7 phr. Non-limiting examples of antioxidants include zinc 2-mercaptomethyl benzimidazole (ZMTI) and polymerized 2,2,4-trimethyl-1,2-dihydroquinoline (TMQ). A mixture of ZMTI and TMQ is also contemplated.

The rubber composition may further include methyl-2-mercaptobenzimidazole (MMBI), zinc-2-methylmethylmercaptobenzimidazole (ZMMBI), or a combination thereof.

In some embodiments, the rubber composition further includes at least one material selected from the group consisting of polybutadiene resins, tertiallycyanurate, and tertially isocyanurate.

The rubber composition may further include zinc oxide. In some embodiments, the rubber composition is present in an amount of about 5 to about 25 phr.

A peroxide curing agent may further be included in the rubber composition.

Disclosed, in further embodiments, is a rubber composition containing: EPDM; a plasticizer; carbon black; a wax; a coagent; zinc oxide; peroxide; and an antioxidant.

The plasticizer may include about 30 to about 50 phr of a paraffinic oil with a molecular weight varying from 390 g/mol to 800 g/mol; and about 5 to about 30 phr of a zinc salt internal lubricant.

In some embodiments, the carbon black includes about 20 to about 50 phr of a N550 type carbon black and about 15 to about 25 phr of a N700 carbon black.

The wax may include about 1 to about 5 phr of a paraffinic wax having a congealing point in the range of about 149 to about 159° F. and about 0.5 to about 4 phr of a low molecular weight polyethylene having a melting point in the range of about 100 to about 108° C.

In some embodiments, the coagent includes about 1 to about 10 phr of a monomethacrylate having a molecular weight in the range of about 150 g/mol to about 189 g/mol and about 1 phr to about 10 phr of another methacrylate having a molecular weight in the range of about 200 to about 250 g/mol.

The zinc oxide may be present in an amount of about 5 to about 25 phr.

In some embodiments, the antioxidant comprises about 1 to about 5 phr ZMTI and about 0.5 to about 4 phr TMQ.

Articles, such as coolant hoses and muffler hangers, are also disclosed.

Disclosed, in other embodiments, is a process for forming an article comprising a rubber composition. The process includes curing a curable composition comprising EPDM. The rubber composition retains at least 30% of elongation at break and/or at least 70% tensile strength after heat aging at 350° F. for 504 hours.

The curable composition may further include a plasticizer, carbon black, a wax, a coagent, zinc oxide, and an antioxidant.

In some embodiments, the curing is performed at a temperature in the range of about 325° F. to about 335° F.

These and other non-limiting characteristics are more particularly described below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a chemical structure diagram of EPDM rubber with a variety of diene monomers.

FIG. 2 includes graphs showing the retention in mechanical properties of conventional EPDM compounds aged at 350° F.

FIG. 3 includes graphs showing the retention in mechanical properties of high heat compounds compared with a conventional EPDM compound (CC2) and silicone aged at 350° F.

FIG. 4 illustrates the morphology of aged EPDM compounds as follows: (a) surface of CC2, (b) surface of a non-limiting embodiment of a high heat compound (HEATBOSS® EPDM 3), (c) fractured cross-section of conventional CC2, (d) fractured cross-section of HEATBOSS® EPDM 3.

FIG. 5 includes graphs showing the retention in mechanical properties of HEATBOSS® EPDM 3 compared with other high heat resistant compounds.

FIG. 6 includes FTIR spectra of EPDM samples before and after heat aging at 350° F.: (a) CC2 and (b) HEATBOSS® EPDM 3.

FIG. 7 includes photographs of (a) a side view of a failed muffler hanger; (b) a full view of a failed muffler hanger; and the performance of the muffler hangers manufactured based on (c) CC2; (d) Optimal HEATBOSS® EPDM 3 and (e) Silicone.

### DETAILED DESCRIPTION

The present disclosure may be understood more readily by reference to the following detailed description of desired embodiments included therein. In the following specification and the claims which follow, reference will be made to a number of terms which shall be defined to have the following meanings.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent can be used in practice or testing of the present disclosure. All publications, patent applications, patents, and other references mentioned herein are incorporated by reference in their entirety. The materials, methods, and articles disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases that require the presence of the named ingredients/steps and permit the presence of other ingredients/steps. However, such description should be construed as also describing compositions, mixtures, or processes as “consisting of” and “consisting essentially of” the enumerated ingredients/steps, which allows the presence of only the named ingredients/steps, along with any impurities that might result therefrom, and excludes other ingredients/steps.

Unless indicated to the contrary, the numerical values in the specification should be understood to include numerical values which are the same when reduced to the same number of significant figures and numerical values which differ from the stated value by less than the experimental error of the conventional measurement technique of the type used to determine the particular value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

Where a plurality of ranges are disclosed, the upper and lower limits of each range may be combined with the limits of the other ranges.

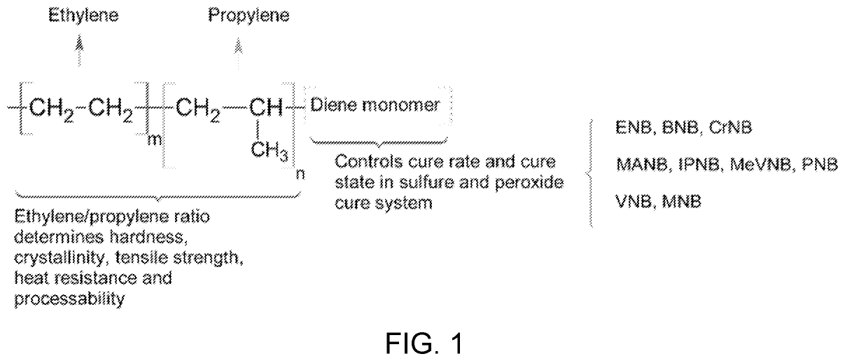

Cautious selection of EPDM and careful design of formulation are the keys to achieve a high heat resistant EPDM with high retention in mechanical properties. The former includes considering chemical structure factors, such as diene content, average molecular weight, molecular weight distribution, and ethylene/propylene composition ratio, etc. The latter involves all compound ingredients such as antioxidants, cure package, plasticizers, reinforcements, coagents, etc. The general chemical structure of an EPDM rubber and functionality of each monomer unit are provided in FIG. 1.

Crosslinking efficiency of EPDM depends on the type and content of diene. The following dienes are listed in reduced efficiency order: 5-Vinylidene-2-norbornene (VNB)>5-Methylene-2-norbornene (MNB)>5-Methallyl-2-norbornene (MANB)>5-Isopropenyl-2-norbornene (IPNB)>5-Methyl-5-vinyl-2-norbornene (MeVNB)>5-Propenyl-2-norbornene (PNB)>5-Crotyl-2-norbornene (CrNB)>5-Ethylidene-2-norbornene (ENB)>5-(2-Butene-2-yl)-2-norbornene (BNB)

For the base polymer of the present disclosure, in particular embodiments, the diene is selected from VNB and MNB.

The diene content in the EPDM may be in the range of about 0 wt % (a trace amount of slightly greater than 0 wt %, 0.2 wt %) to about 10 wt %, including about 1 wt % to about 4 wt %, and about 1.3 wt % to about 2 wt %. In some embodiments, the diene content is greater than or equal to about 0.2 wt % and/or less than or equal to about 1.7 wt %.

The ethylene content in the EPDM may be in the range of about 40 wt % to about 80 wt %, including from about 50 wt % to about 70 wt %, and about 55 wt % to about 65 wt %.

The propylene content in the EPDM may be in the range of about 25 wt % to about 50 wt %, including from about 30 wt % to about 45 wt %, and about 35 wt % to about 40 wt %.

To form the rubber composition of the present disclosure, the EPDM is compounded with a peroxide curing agent and additional additives. Non-limiting examples of additional additives that may be included are plasticizers, fillers, waxes, coagents, activators, antioxidants, antiozonants, processing aids and/or colorants/pigments.

The plasticizer may be an extender oil.

Non-limiting examples of plasticizers include paraffinic oils, naphthenic oils, aromatic oils, and zinc salt internal lubricants. One or more plasticizers may be used in combination.

The paraffinic oil may have a molecular weight varying in the range of 390 g/mol to 800 g/mol. In some embodiments, the paraffinic oil is present in the rubber composition in an amount of about 20 to about 60 parts per hundred parts EPDM (phr), including from about 35 to about 46 phr.

Paraffinic oil can have any viscosity between 20 cSt to 550 cSt according to ASTM D445 at 40° C., such as Sunpar 2280, Hyprene P1505BS, Hyprene V175BS, Paulsboro VP BS 150, while the Naphthenic oil can have a viscosity between 5 cst to 40 cst according to ASTM D445 at 40° C., such as Stan_Plas 105, Hyprene L1200, Corsol 1200. A single oil or a combination of different oils can be used.

The zinc salt internal lubricant may be present in the rubber composition in an amount of about 5 to about 30 phr, including from about 12 to about 18 phr.

The zinc salt may be zinc stearate. One non-limiting example of a zinc stearate internal salt lubricant is sold under the name STRUCKTOL®.

In some embodiments, a combination of a paraffinic oil and a zinc salt internal lubricant may be utilized. In particular embodiments, the amount of the paraffinic oil is about 35 to about 46 phr and the amount of the zinc salt internal lubricant is about 12 to about 18 phr.

The filler may be carbon black. In some embodiments, more than one type of carbon black is included. Non-limiting examples of carbon black grades include N110, N220, N339, N550, N650, N774 and N990.

The carbon black may be present in an amount of about 10 to about 100 phr, including from about 30 to about 80 phr, and about 40 to about 70 phr.

In some embodiments, the carbon black includes a mixture of a N550 type carbon black (e.g., Sterling 6630) and a N700 type carbon black (e.g., Sterling NS). In particular embodiments, the amount of N550 type carbon black is in the range of about 30 to about 40 phr and the amount of N700 carbon black is in the range of about 15 to about 25 phr.

Non-limiting examples of waxes include paraffinic waxes and low molecular weight polyethylene. The wax may be present in an amount of about 1 to about 20 phr, including from about 3 to about 7 phr.

The paraffinic wax may have a congealing point in the range of about 149 to about 156° F.

In some embodiments, the low molecular weight polyethylene has a melting point in the range of about 100 to about 108° C.

The wax may include a mixture of a paraffinic wax and a low molecular weight polyethylene. In particular embodiments, the paraffinic wax is present in an amount of about 2 to about 4 phr and the low molecular weight polyethylene is present in an amount of about 1 to about 3 phr.

The wax can be one or combination of paraffin wax, microcrystalline wax, polyethylene wax and polypropylene wax. Paraffin wax may have melting point between 35° C. to 80° C. Microcrystalline wax may have melting temperature of 50° C. to 120° C. Polyethylene wax may have melting temperature of 85° C. to 110° C. Polypropylene wax may have melting temperature of 85° C. to 110° C.

Non-limiting examples of coagents include methacrylate (e.g., monomethacrylate) type coagents.

The coagent may be present in the rubber composition in an amount of about 1 to about 20 phr, including from about 3 to about 10 phr.

The monomethacrylate may have a molecular weight in the range of 150 g/mol to 189 g/mol.

The methacrylate may have a molecular weight in the range of 200 g/mol to 250 g/mol.

In some embodiments, the coagent includes a mixture of a monomethacrylate and another methacrylate. In particular embodiments, the monomethacrylate is present in an amount of about 3 to about 6 phr and the other methacrylate is present in an amount of about 3 to about 6 phr.

The activator may be present in the rubber composition in an amount of about 5 to about 25 phr.

In some embodiments, the activator is zinc oxide. The zinc oxide may be present in an amount of about 4 to about 45 phr, including from about 10 to about 17 phr.

The antioxidant may be present in the rubber composition in an amount of about 1 to about 10 phr, including from about 3 to about 7 phr.

Non-limiting examples of antioxidants include zinc 2-mercaptomethyl benzimidazole (ZMTI) and polymerized 2,2,4-trimethyl-1,2-dihydroquinoline (TMQ).

In particular embodiments, the antioxidant is a mixture of about 1 to about 3 phr ZMTI and about 2 to about 4 phr TMQ.

The EPDM and other components may be mixed in advance of the inclusion of the peroxide curing agent. Curing may be performed at a temperature in the range of about 320° F. to about 340° F., including from about 325° F. to about 335° F., about 327° F. to about 333° F., and about 329° F. to about 331° F.

The rubber may have a tensile strength of greater than 10 MPa.

The rubber may also exceed long term heat aging properties of known EPDM compounds.

In some embodiments, the rubber is able to retain at least 80% (e.g., 82%) of its original tensile strength and at least 40% (e.g., 53%) of elongation at break after 3 weeks of heat aging at 350° F., which is comparable to a typical silicone under the same again conditions.

The rubber compositions of the present disclosure provide an alternative, cost effective, solution to elastomers serving at high temperature (type E application in automotive industry, for example), which is normally dominated by more costly silicone.

The rubber compositions of the present disclosure may be useful for high temperature (e.g., about 350° F. or greater) applications, including automotive, electronics, aerospace, and construction applications.

Non-limiting examples of articles that may be made from the compositions of the present disclosure include hoses (e.g., coolant hoses), belts (e.g., under the hoods belts), muffler hangers, vibration dampers, and roofing membranes.

The following examples are provided to illustrate the devices and methods of the present disclosure. The examples are merely illustrative and are not intended to limit the disclosure to the materials, conditions, or process parameters set forth therein.

### EXAMPLES

EPDM Base Polymers

A few of commercial grades of EPDM polymers, were examined. The specifications of each EPDM including diene content, ethylene content, molecular weight distribution (MWD), and Mooney viscosity (MV) which critically control the properties of the final product, are listed in Table 1.

TABLE 1
Specification of EPDM polymers

| | Diene | Ethylene | | MV |
|---|---|---|---|---|
| | content | content | | (ML 1 + 4 @ |
| EPDM Base | (wt. %) | (wt. %) | MWD^{b} | 257° C.)^{c} |
| EPDM 1 | 0 | 51 | B | L |
| EPDM 2 | 1.5-2.5^{a} | 60 | N | L |
| EPDM 3 | 1.5-2.5 | 66 | N | M |
| EPDM 4 | 4.5-7.5 | 55 | BM | H |
| EPDM 5 | 7.5-10 | 52 | N | H |

^{a}High peroxide crosslinking efficiency diene type (the others are low crosslinking efficiency type)
^{b}H = High; L = Low; M = medium
^{c}BM = Bi-modal; N = Narrow; B = Broad

Compounding

Compounding was carried out in a 1.6-liter capacity rubber internal mixer (BR-1600 Banbury laboratory mixer, Farrel, USA) at a fill factor of 80% using a standard “up-side-down” mixing procedure. The mixing was initiated by the simultaneous addition of all ingredients (according to Table 2 and Table 6) except the curing package into the mixing chamber. The rotor speed varied from 60 to 80 rpm and the mixing was carried out for about 1.5 min. The compounding was continued by subsequent addition of the curing package including curatives and coagents into the mix once the temperature reached 160° F. The final compound was discharged when its temperature reached 220° F. Mixing was completed using a 6-inch two-roll mill (Black Clawson, USA) at ambient temperature to ensure a uniform mixture was achieved. The resultant rubber compound in the form of sheet was employed for further testing. The sheets were kept in the room temperature overnight, to remove any thermal history of the compounds. Vulcanization of the uncured rubber compounds was performed using a compression molding technique where they were compressed into a sheet and subsequently cured in an AF25 press (Hudson Machinery, USA) at a pressure of 150 bar for about 15 min (i.e., t₉₀+5 min). The temperature of the vulcanizing machine mold was 330° F. unless stated otherwise. To halt any further curing reaction, the cured samples were removed from the press and instantly placed in a cold-water bath once the cure time was completed. The cured sheet was kept at room temperature before testing.

Characterization

Mooney Viscosity

The Moony viscosity (MV) of different uncured formulated EPDM compounds was measured with a MV2000 Mooney viscometer (Alpha Technologies, USA) after the slabs were conditioned at room temperature for 24 hours. The measurements were conducted using a large rotor in accordance with ASTM D1646, with a testing procedure of one-minute preheating time and a four-minute testing time (ML 1+4 at 212° F.).

Curing Behavior

To get an idea about the cure characteristics of the EPDM compounds, their cure behavior was measured using an Alpha Technology moving die rheometer (MDR) in accordance with ASTM D5289. The torque vs time rheographs were employed to obtain the curing characteristics including 90% cure time (t₉₀), cure onset time (tₛ), maximum torque (M_{H}), minimum torque (M_{L}), torque difference (ΔM=M_{H}−M_{L}), and cure rate index

$$( CRI = \frac{100}{{t}_{90} - {t}_{s}} )$$

which defines the overall rate of cure. Prior testing, the as-mixed uncured sample was stored at room temperature for 24 hours. Mooney scorch of the samples was measured by (ML 1+4 at 270° F.), the commonly recommended temperature for injection molding of EPDM. The Mooney scorch time (t₅) and t₃₅ is defined as the time for an increase of 5 and 35 units above the minimum viscosity, respectively.

Heat Aging

Accelerated heat aging is typically used by the automotive industry for quality assurance testing of elastomeric vulcanizates. The mechanical test specimens were first punched according to what was described in the “Mechanical properties” section. The fabricated test specimens were then oven aged in an air-ventilated oven at 320 and 350° F. for the desired aging hours and characterized with respect to physical properties according to ASTM D-2000 standard which specifies per many automotive applications. All physical property measurements were conducted 24 hours after the specimens were removed from the hot air oven.

Aging Chemistry

The surface chemistry change during heat-aging was monitored by Fourier transform infrared spectroscopy (FTIR) using a Nicolet 470 Instrument (Nicolet Inc, USA) in the range 4000 to 400 cm⁻¹ with 32 scans at a resolution of 4 cm⁻¹.

Mechanical Properties

Tensile properties, namely ultimate tensile strength (σᵤ) and elongation at break (ε_{b}) and tear strength (Tₛ) of the compounds were evaluated using T2000 Tensometer (Alpha, USA) with a cross head speed of 500 mm/min. The specimens needed for tensile and tear tests were die cut from the compression-molded sheets as per standard ASTM D412 and ASTM D 624 (type C specimen). Hardness of the vulcanizates (shore A) was determined by recording at least five measurements on the stack of compression-molded sheets, with a total height of 6 mm at room temperature after 3 seconds according to ASTM D-2240. Compression set test was performed in accordance with ASTM D-395 at 25% compression of the original thickness for 70 hours at 212° F.

Morphological Study

Both the sample surface and fractured surface (cross-section) after heat aging were observed by a digital microscope system (VHX-700FE, Keyence, Japan).

### Results and Discussion

Selecting the Base EPDM

To have a better understanding of how EPDM characteristics, such as diene content, diene type, MWD, viscosity, ethylene/propylene ratio affect compound heat resistance, several commercially available EPDM elastomers with varying characteristics were selected for evaluation. Their compounds were coded as CC1 to CC5 are given in Table 2.

TABLE 2
Formulation of conventional EPDM compounds
in parts per hundred rubber (phr)

| | Conventional EPDM compounds | | | | |
|---|---|---|---|---|---|
| Ingredients | CC1 | CC2 | CC3 | CC4 | CC5 |
| EPDM 1 | 100 | — | — | — | — |
| EPDM 2 | — | 100 | — | — | — |
| EPDM 3 | — | — | 100 | — | — |
| EPDM 4 | — | — | — | 100 | — |
| EPDM 5 | — | — | — | — | 100 |
| Plastisizer1 | 40 | 30 | 50 | 70 | 50 |
| Plastisizer2 | — | — | — | — | — |
| Carbon black1 | 55 | 60 | 70 | 60 | 60 |
| Wax1 | 3 | 2 | 2 | 10 | 10 |
| Peroxide curative | 6.5 | 5 | 6 | 8 | 8 |
| Coagent1 | 5.5 | 5 | 6 | 7 | 7 |
| Zinc oxide | 30 | — | — | 40 | 45 |
| Antioxidant1 | 2 | 2 | — | 3 | 3 |
| Antioxidant2 | 2 | — | 2 | 3 | 3 |
| Additive1 | 2 | 1 | 1 | 3 | 3 |
| Additive2 | — | — | — | 4 | 3 |
| Additive3 | 2 | — | — | 2 | 2 |
| Additive4 | — | — | — | 3 | 3 |
| Total | 248 | 205 | 237 | 313 | 297 |

The effect of different grades of EPDM on the cure characteristics and Mooney viscosity of the EPDM conventional vulcanizates is shown in Table 3. M_{H} and M_{L} can be the direct indication of the modulus (or stiffness) and viscosity of the compounds, respectively. The cure characteristics are controlled, not only by diene content, but also by other structural properties such as ethylene/propylene ratio, MWD, etc. The comparison between curing characteristics of the CC2 and CC3 reveal, at the almost same diene content and ethylene/propylene ratio, the cure behavior of EPDM vulcanizates is strongly influenced by diene type. Using a high peroxide crosslinking efficiency (s) diene type resulted in higher values of CRI and ΔM.

TABLE 3
MDR cure results, Mooney viscosity and Mooney
scorch of the conventional EPDM compounds

| | | Sample codes | | | | |
|---|---|---|---|---|---|---|
| Results | | CC1 | CC2 | CC3 | CC4 | CC5 |
| MDR | t_{S} (min) | 1.38 | 1.07 | 1.01 | 1.28 | 1.64 |
| results @ | t₉₀ (min) | 10.69 | 9.18 | 9.41 | 9.67 | 13.4 |
| 330° F. | M_{L} (N. m) | 0.83 | 1.01 | 0.96 | 0.71 | 0.85 |
| | M_{H} (N. m) | 9.03 | 10.69 | 11.7 | 9.30 | 9.52 |
| | ΔM (N. m) | 8.20 | 9.68 | 10.47 | 8.59 | 8.46 |
| | CRI (%/min) | 10.84 | 12.33 | 11.90 | 11.91 | 8.50 |
| Mooney | MV | 36.8 | 47 | 44.2 | 46.9 | 47.5 |
| viscosity @ | | | | | | |
| 212° F. | | | | | | |
| Mooney | MV | 24.4 | 27 | 26.1 | 32 | 31.7 |
| scorch | t₅ (min) | 8.48 | 15.97 | 5.73 | 7.27 | 7.26 |
| @ 270° F. | t₃₅ (min) | 51.53 | NA | 22.28 | 31.12 | 38.45 |

The original mechanical properties and retention of these properties after oven-aging in conventional compounds, measured in different time intervals, are summarized in Table 4. The data indicates that a progressive deterioration in the mechanical performance of the conventional EPDM compounds, exposed to heat, leads to a significant decrease in mechanical properties, including ε_{b} and σᵤ accompanied by the higher values of hardness. Compounds based on low ε diene type (all CCs except CC2) quickly lose their extensibility and gain significant hardness after high-temperature aging. CC4 and CC5 exhibit a very similar trend in terms of tensile strength and elongation at break retention drop rate.

TABLE 4
Summary of mechanical behavior of conventional
EPDM compounds after aging at 350° F.

| Mechanical | Aging | Sample codes | | | | |
|---|---|---|---|---|---|---|
| properties | time(h) | CC1 | CC2 | CC3 | CC4 | CC5 |
| ε_{b} (%) | 0 | 351 | 343 | 443 | 477 | 556 |
| ε_{b} retention (%) | 0 | 100 | 100 | 100 | 100 | 100 |
| | 72 | 45 | 105 | 35 | 38 | 37 |
| | 264 | 15 | 35 | 10 | 8 | 6 |
| | 504 | — | 8 | — | — | — |
| σᵤ (MPa) | 0 | 10.28 | 9.6 | 11.29 | 12.61 | 13.76 |
| σᵤ retention (%) | 0 | 100 | 100 | 100 | 100 | 100 |
| | 72 | 52 | 98 | 45 | 49 | 44 |
| | 264 | 22 | 32 | 19 | 14 | 12 |
| | 504 | — | 20 | — | — | — |
| Shore A Hardness | 0 | 58 | 54 | 56 | 56 | 64 |
| Δ Hardness | 72 | 1 | 0 | 2 | 10 | 5 |
| | 264 | 8 | 3 | 10 | 15 | 8 |
| | 504 | — | 10 | — | — | — |
| Compression set | 0 | 16 | 18.5 | 15.2 | 25.3 | 30.8 |
| (%) | | | | | | |
| Ts (N/mm) | 0 | 27.3 | 25.5 | 26.9 | 38.5 | 38.7 |

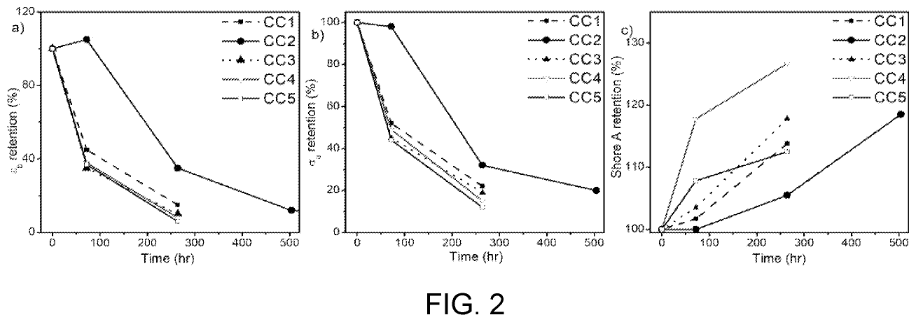

For the sake of visual comparison convenience, the retention in mechanical properties of the CCs was plotted in FIG. 2. It is shown that compound using higher level of low ε diene type EPDM deteriorates more in elongation and hardness in heat aging. However, the mechanical properties of the CC2 compounds were found to be significantly less affected by high heat aging than other conventional EPDM ones. After 11 days, CC2 still maintained 35% of its original extensibility and 29% of tensile strength. The compound hardness change was 3 shore A units, which is another solid indication of better mechanical stability of CC2 against heat aging. This is likely related to the highly efficient peroxide cure fueled by the specific chemical structure of the diene. In the subsequent investigation, EPDM2 is used as the base polymer.

Formulation Design for High Heat Resistance

Rubber materials in the automotive industry are designated based on two criteria: heat aging resistance (type) and oil swelling resistance (class). Performance requirements, according to the type of service specified by SAE J200, are given in Table 5.

TABLE 5
Basic requirements for different types of rubber
materials based on heat aging resistance.

| | Test temperature | |
|---|---|---|
| Type | (° F.) | Basic requirements |
| A | 158 | After heat aging for 70 h at the |
| B | 212 | temperature required for each type: |
| C | 257 | The changes in tensile strength: |
| D | 302 | not more than ±30% |
| E | 347 | The changes in elongation at |
| F | 392 | break: not more than −50% |
| G | 437 | The changes in hardness: not |
| H | 482 | more than ±15 points |
| J | 527 | |
| K | 572 | |

Traditionally, sulfur-cured EPDM compounds were used for type C applications, however, peroxide-cured EPDM compounds developed over the last decade have gained ever-growing interest in type D applications due to their improved thermal resistance. According to SAE J200, there is not even a single peroxide-cured EPDM compound that can withstand over 347° F. for long term service, which makes known EPDM compounds incapable of serving in type E applications, while some special purpose polymers including silicone can provide that stability. Recently, Dow Chemical Co. introduced a high-temperature EPDM formulation, illustrating extended time periods, e.g., 302° F. for 1008 h with over 50% and 70% retention of tensile strength and elongation at break, respectively. However, technology advancements in the internal combustion engines have been made in terms of turbocharging, exhaust gas recirculation, selective catalytic reduction and AdBlue technology still are demanding extremely high-temperature resistance for elastomer parts.

Further compositions are summarized in Table 6.

TABLE 6
Formulations of high heat resistant EPDM
compounds (HEATBOSS ® EPDM)
in parts per hundred rubber (phr)

| | HEATBOSS ® EPDM compounds | | |
|---|---|---|---|
| Ingredients | 1 | 2 | 3 |
| EPDM 2 | 100 | 100 | 100 |
| Plasticizer1 | 30-40 | 35-45 | 35-46 |
| Plasticizer2 | — | — | 12-18 |
| Carbon black1 | 50-60 | 55-65 | 30-40 |
| Carbon black2 | — | — | 15-35 |
| Wax1 | 2 | 2 | 3 |
| Wax2 | — | — | 2 |
| Peroxide curative | 6-7 | 6.5-7.5 | 5.5-7.5 |
| Coagent1 | 5-6 | 5.5-6.5 | 3-6 |
| Coagent2 | — | — | 1-5 |
| Zinc oxide | 20 | 20 | 10-20 |
| Antioxidant1 | 2 | 2 | 2 |
| Antioxidant2 | 2 | 2 | 3 |
| Additive1 | 1 | 1 | 2 |
| Additive3 | — | 1 | 2 |
| Total | 218-240 | 230-252 | 225.5-291.5 |

Plasticizer1 is a paraffinic oil with a molecular varying from 390 to 800 g/mol. Carbon black1 is a N550 type carbon black. Wax1 is a paraffinic wax having a congealing point from 149-156° F. Coagent1 is a monomethacrylate type with a molecular weight from 150-189 g/mol. Plasticizer2 is a zinc salt internal lubricant. Carbon black2, is a N700 type carbon black. Wax2 is a low molecular weight polyethylene with a melting point from 100-108° C. Coagent2 is another type of methacrylate or polybutadiene resin or isocyanurate or cyanurate. The methacrylate may have molecular weight ranging from 200-250 g/mol. Antioxidant2 is a polymerized 2,2,4-trimethyl-1,2-dihydroquinoline (TMQ). Antioxidant 1 is zinc 2-mercaptomethyl benzimidazole (ZMTI).

The MDR cure results, Mooney viscosity, and Mooney scorch of all HEATBOSS® EPDMs were compared with an internal silicone compound and other high heat resistant EPDM formulations (published by Dow) in Table 7. It was found that M_{L} and CRI of HEATBOSS® EPDMs were lower than those of other high heat compounds, including silicone and Dow high heat EPDM compounds. This means that HEATBOSS® EPDMs can be processed more easily than other compounds. It is also noted that the Mooney viscosity and Mooney scorch of the optimal HEATBOSS® EPDM 3 compound are like those of silicone formulations.

TABLE 7
MDR cure results, Mooney viscosity, and Mooney scorch
of present high heat resistant compounds in comparison
with the other high heat resistant formulations

| | | Sample codes | | | | | |
|---|---|---|---|---|---|---|---|
| | | HEATBOSS ® EPDM | | | | | |
| Results | | 1 | 2 | 3 | Silicone | DowHH1 ª | DowHH2 ª |
| MDR | t_{S} (min) | 1.05 | 0.95 | 1.48 | 0.86 | 0.50 | 0.50 |
| results | t₉₀ (min) | 9.35 | 8.61 | 8.71 | 4.10 | 4.10^{b} | 4.20^{b} |
| @ 330° F. | M_{L} (N. m) | 0.85 | 0.84 | 0.46 | 0.86 | 2.30 | 2.70 |
| | M_{H} (N. m) | 11.57 | 10.94 | 8.01 | 14.40 | 15.60 | 18.50 |
| | ΔM (N. m) | 10.72 | 10.10 | 7.55 | 13.54 | 13.30 | 15.80 |
| | CRI (%/min) | 11.79 | 13.05 | 13.83 | 22.02 | 27.77 | 27.02 |
| Mooney | MV | 43.30 | 34.65 | 45.0 | 22.0 | 81.4 | 89 |
| viscosity | | | | | | | |
| @ 212° F. | | | | | | | |
| Mooney | MV | 29.6 | 22.61 | 14.9 | 12.5* | — | — |
| scorch | t₅ (min) | 5.83 | 6.29 | 11.1 | 15.2* | — | — |
| @250° F. | t₃₅ (min) | 24.29 | 22.35 | 24.87 | 18.02* | — | — |

*Mooney @ scorch at 270° F.
^{a}the samples are cured at ~355° F.
^{b}t₉₅ is reported

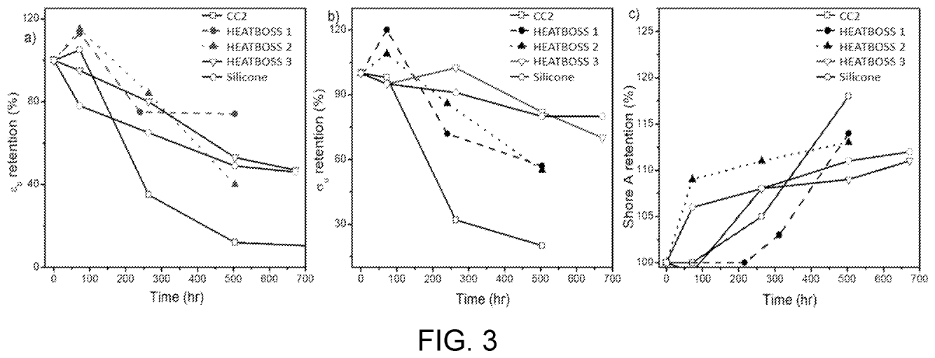

The original mechanical properties of HEATBOSS® EPDMs and their retention after heat aging are compared with those of other heat resistant formulations in Table 8. The results reveal that HEATBOSS® EPDMs almost meet the tensile requirement (σᵤ>10 MPa). As can be seen from the table, considering elongation at break, the HEATBOSS® EPDM 3 compound has the highest extensibility among the HEATBOSS® EPDMs. The comparison of the original mechanical properties of HEATBOSS® EPDMs with other high heat resistant EPDM formulations reveals that the HEATBOSS® EPDM 3 compound's mechanical performance lies within the acceptable range for high heat EPDM compounds. The superior properties of the HEATBOSS® EPDM 3 compound confirms that the appropriate selection of the EPDM base and compounding ingredients play a critical role in defining the performance of the final compound. FIG. 3 compares the variation of the retention in mechanical properties of different HEATBOSS® EPDMs at 350° F. It is worth mentioning that HEATBOSS® EPDM 3 also provides excellent mechanical properties retention at 350° F., which is in the typical range for silicone-based compound. High elongation at break and tensile strength retention along with a low change in hardness enables the HEATBOSS® EPDM 3 compound to compete with silicone-based counterpart in serving in type E applications by exhibiting this superior heat aging performance. After four weeks of heat aging at 350° F., the HEATBOSS® EPDM 3 material still retains 47% and 70% of elongation at break and tensile strength, respectively, which is quite comparable to those of silicone formulation (46% retention of elongation at break and 80% retention of tensile strength). These features are required for type E applications and cannot be provided by commercial EPDM compounds so far. As shown before, conventional EPDM compounds lost their elasticity and toughness at 350° F. over the same period of heat aging.

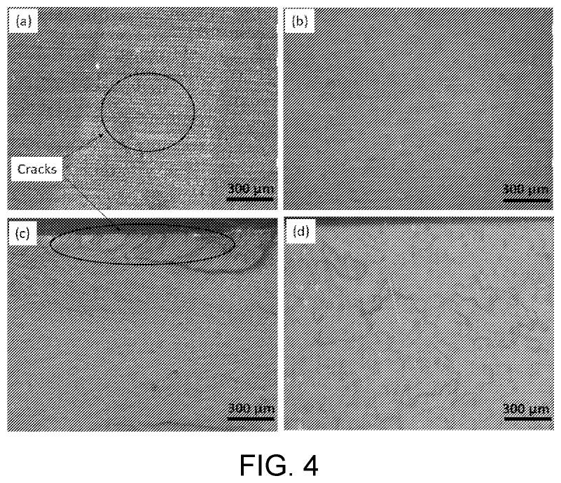

A digital microscope was used to study the surface and cross-section morphology of the EPDM-base compound after exposure to heat. The effect of heat aging at 350° F. for 672 h on the surface and cross-section of the HEATBOSS® EPDM 3 and CC2 compounds is shown in FIG. 4. Rough surface and crack appearance were observed on the surface of the CC2 sample (FIG. 4a) which shows the occurrence of oxidation and ozone cracking on the surface of the product during aging. The propagation of the surface-initiated cracks into the bulk of the material, after being fractured, can be seen in FIG. 4c. Another conspicuous behavior is the smooth fractured surface of the sample, which is correlated to the embrittlement accompanied by a loss in elasticity caused by degradation. In contrast, the high heat EPDM compound, the HEATBOSS® EPDM 3 surface (FIG. 4b) indicates that there are no/very few cracks on the exposure surface which approves its excellent resistance to oxidation and ozone cracking. Morphology of the fractured surface of the compound illustrated in FIG. 4d showed that there are no noticeable cracks in the edge of the exposure. It can also be seen that the fractured surface of the HEATBOSS® EPDM 3 compound is rough which shows that the material is still elastic after 672 h of heat exposure. These observations are in good agreement with the proper retention of the extensibility of high heat EPDM compound. The exposure surface and fractured surface microtopography once again confirmed that the extent of surface damage and embrittlement in the HEATBOSS® EPDM 3 is gentler compared to CC2.

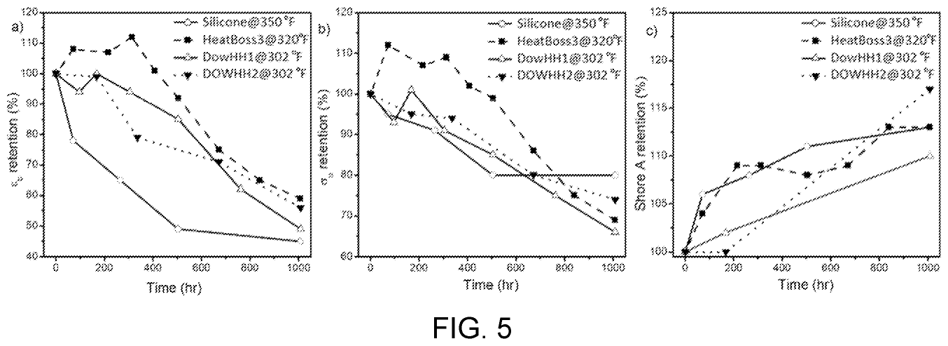

The mechanical stability of the most recent high heat formulations published by Dow was compared with experimental results for HEATBOSS® EPDM 3, as shown in FIG. 5. HEATBOSS® EPDM 3 showed noticeably higher heat resistance at higher temperatures in comparison with the Dow formulations. Therefore, HEATBOSS® EPDM 3 appears to be superior for automotive high temperature requirements. The present technology can address the requirements of the modern engine's compartment for durable elastomeric parts at high temperatures, in particular, coolant hoses, transmission belts, muffler hangers, and vibration dampeners, which are demanding for extremely high heat resistance requirements for extended time periods.

TABLE 8
Summary of mechanical behavior of present high heat resistant compounds
and the other high heat resistant formulations after aging

| | Aging | HEATBOSS ® EPDM | | | | | | |
|---|---|---|---|---|---|---|---|---|
| Mechanical | time | 1 | 2 | 3 | 3 | Silicone^{a} | DowHH1 | DowHH2 |
| properties | (h) | @350° F. | @350° F. | @350° F. | @320° F. | @350° F. | @302° F. | @302° F. |
| ε_{b} (%) | 0 | 343 | 371 | 527 | 480 | 540 | 405 | 453 |
| ε_{b} retention | 0 | 100 | 100 | 100 | 100 | 100 | 100 | 100 |
| (%) | 72 | 113 | 115 | 94.7 | 108 | 78 | — | — |
| | 96 | — | — | — | — | — | 94 | |
| | 168 | — | — | — | — | — | 100 | 99 |
| | 216 | — | — | — | 107 | — | — | — |
| | 264 | 75 | 84 | 80.1 | — | 65 | — | — |
| | 305 | — | — | — | — | — | 94 | — |
| | 312 | — | — | — | 112 | — | — | — |
| | 336 | — | — | — | — | — | — | 79 |
| | 408 | — | — | — | 101 | — | — | — |
| | 504 | 37 | 40 | 53 | 92 | 49 | 85 | — |
| | 672 | — | — | 47 | 75 | 46 | — | 71 |
| | 762 | — | — | — | — | — | 62 | — |
| | 840 | — | — | — | 65 | — | — | — |
| | 1008 | — | — | — | 59 | 45 | 49 | 56 |
| σᵤ (MPa) | 0 | 9.88 | 9.9 | 10.8 | 10.1 | 7.8 | 8.6 | 10.9 |
| σᵤ retention | 0 | 100 | 100 | 100 | 100 | 100 | 100 | 100 |
| (%) | 72 | 120 | 109 | 94.1 | 112 | 95 | — | — |
| | 96 | — | — | — | — | — | 93 | — |
| | 168 | — | — | — | — | — | 101 | 95 |
| | 216 | — | — | — | 107 | — | — | — |
| | 264 | 72 | 86 | 102.5 | — | 91 | — | — |
| | 305 | — | — | — | — | — | 91 | — |
| | 312 | — | — | — | 109 | — | — | — |
| | 336 | — | — | — | — | — | — | 94 |
| | 408 | — | — | — | 102 | — | — | — |
| | 504 | 57 | 55 | 82.3 | 99 | 80 | 85 | — |
| | 672 | — | — | 70 | 86 | 80 | — | 80 |
| | 762 | — | — | — | | — | 75 | — |
| | 840 | — | — | — | 75 | — | — | — |
| | 1008 | — | — | — | 69 | 80 | 66 | 74 |
| Shore A | 0 | 57 | 54 | 61 | 61 | 62 | 68 | 72 |
| Hardness | 72 | 57 | 5 | 0 | 3 | 4 | — | — |
| Δ Hardness | 168 | — | — | — | — | — | 1 | 0 |
| | 216 | — | — | — | 6 | — | — | — |
| | 264 | 2 | 6 | 5 | — | 5 | — | — |
| | 312 | — | — | — | 6 | — | — | — |
| | 504 | 8 | 8 | 6 | 5 | 7 | — | — |
| | 672 | — | — | 7 | 6 | 7 | — | — |
| | 840 | — | — | — | 8 | — | — | — |
| | 1008 | — | — | — | 8 | 8 | 7 | 12 |
| Compression | 0 | 15.9 | 15.1 | 20.1 | 20.1 | 11 | 19.8^{c} | 20^{c} |
| set (%) | | | | | | | | |
| Ts (N/mm) | 0 | 24.5 | 27.8 | 29.2 | 29.2 | 21.0 | — | — |

^{a} Silicon formulation is according to a commercial compound
^{b} The compression set is after 22 hours at room temperature

TABLE 8a
Properties of HEATBOSS ® EPDM 3 after 70 hours aging at 392°
F. to study the requirements of F1 grade of ASTM.

| | | | | Basic |
|---|---|---|---|---|
| | | | | requirements of |
| Mechanical | Initial | After 70 hrs | Property | F grade- after |
| properties | properties | aging | change | 70 hrs at 392° F. |
| ε_{b} (%) | 527 | 377 | | |
| ε_{b} retention | | | −28.4% | −30% |
| (%) | | | | |
| σᵤ (MPa) | 10.8 | 9.7 | | |
| σᵤ retention | | | −10.9% | −50% |
| (%) | | | | |
| Shore A | 61 | 73 | | |
| Hardness | | | | |
| Δ Hardness | | | 12 points | 15 points |

The results at Table 8a showed that HEATBOSS® EPDM 3 can pass Basic requirement for Grade F (F1 spec). Before HEATBOSS® EPDM 3, just silicone and FKM elastomers would be able to meet this requirement.

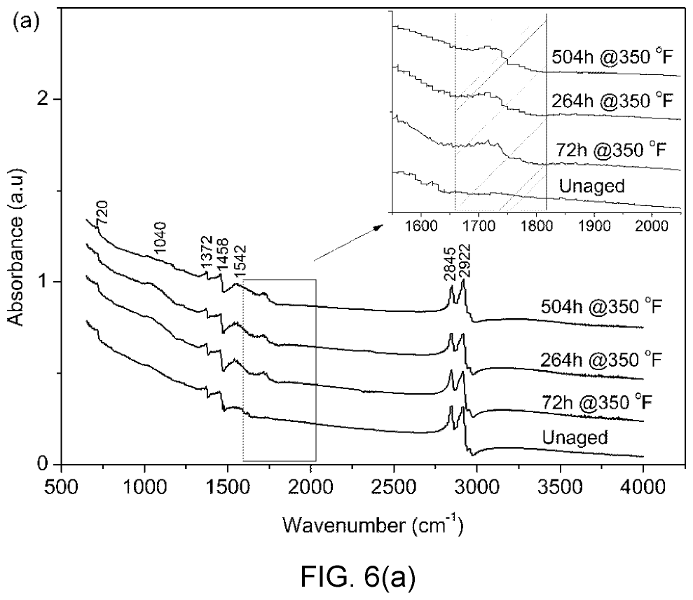

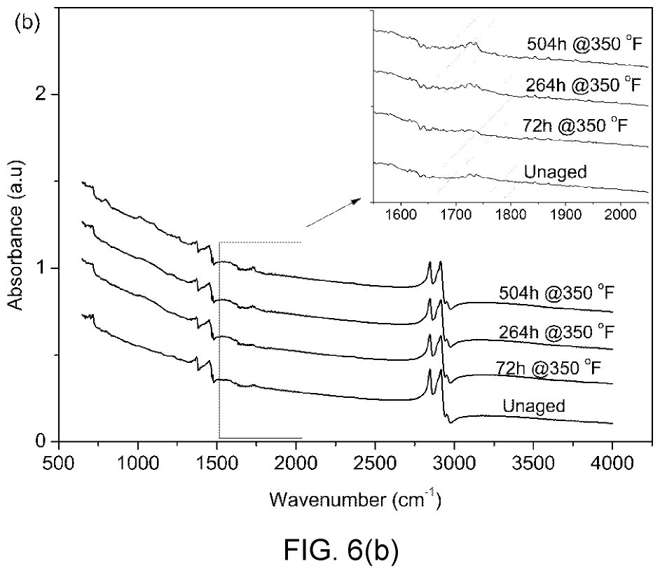

In order to get an idea about the chemistry involved during accelerated heat aging, the effect of various exposure times on the chemical structure of the EPDM samples was studied by FTIR on CC2 and HEATBOSS® EPDM 3. The peaks observed at 2922 cm⁻¹, 2845 cm⁻¹, 1542 cm⁻¹, 1458 cm⁻¹, 1372 cm⁻¹, 1040 cm⁻¹ and 720 cm⁻¹ were assigned to the asymmetric stretching vibration of methylene in the saturated hydrocarbon backbone, symmetric stretching vibration of methylene, C═C stretching vibration, —CH₂— scissoring vibration, symmetric C—H stretching vibration of methyl, symmetric vibration of C—O—C in aliphatic ester and methylene rocking vibration of (CH₂)ₙ where n≥4, respectively. It was reported that the more severely the EPDM compound thermally degrades, the more C═O contents it forms. The formation of the carbonyl group, C═O band which its absorption band typically lies from 1650 to 1800 cm⁻¹. The FTIR spectrum was used to assesses the degree of degradation resulting from oxidation of the polymer. FIG. 6 shows the evolution of C═O peak region over time during heat aging of CC2 and HEATBOSS® EPDM 3. The significant growth in the C═O region for CC2 during the course of high heat aging (FIG. 6a) showed that this sample has been severely degraded. This correlates to the severe loss in mechanical properties observed previously in the case of the CC2 compound. In contrast, a negligible change in the C═O region of HEATBOSS® EPDM 3 (FIG. 6b) compound over time confirms its high heat aging resistance, which enables it to retain mechanical properties after aging.

Cure Behavior of HEATBOSS® EPDM 3

HEATBOSS® EPDM 3 was subjected to further investigation by studying the effect of curing temperature on retention in mechanical properties. HEATBOSS® EPDM 3 was cured at various temperatures and the cure characteristics are given in Table 9. By increasing the cure temperature, shorter scorch time was recorded. Decreasing scorch time would accelerate the onset of vulcanization which results in a lower 90% cure time (t₉₀), and a higher cure rate (CRI) necessitates shorter time to reach the final cure steps. The results reveal that the cure behavior of HEATBOSS® EPDM 3 at 350° F., whose tₛ=0.9 min. and t₉₀=3.51 min., is close to that of silicone, whose tₛ=0.86, t₉₀=4.10 as given in Table 7. This means that HEATBOSS® EPDM 3 can be readily molded and cured in the same way as the silicone.

TABLE 9
Effect of curing temperature on cure
characteristics of HEATBOSS ® EPDM 3

| | | | | | Δ_{M} = | M₉₀ = | |
|---|---|---|---|---|---|---|---|
| Curing | | | | | M_{H} − | M_{L} | CRI |
| temperature | t_{S} | t₉₀ | M_{L} | M_{H} | M_{L} | 0.9ΔM | (%/ |
| (° F.) | (min) | (min) | (N. m | (N. m | (N. m) | (N. m) | min) |
| 320 | 2.10 | 16.35 | 0.54 | 9.16 | 8.62 | 8.29 | 7.01 |
| 330 | 1.48 | 8.71 | 0.46 | 8.01 | 7.55 | 7.25 | 13.83 |
| 340 | 1.11 | 5.52 | 0.46 | 7.64 | 7.18 | 6.93 | 22.67 |
| 350 | 0.9 | 3.51 | 0.44 | 7.00 | 6.56 | 6.34 | 38.31 |

The original mechanical properties and property retention of HEATBOSS® EPDM 3 cured in various temperatures are listed in Table 10. HEATBOSS® EPDM 3 showed that it can fulfill the general requirements for rubber parts (ε_{b}>400% and σᵤ>10 MPa) at all curing temperatures. However, the highest retention in mechanical properties was observed for HEATBOSS® EPDM 3 cured at 340° F.

TABLE 10
Effect of curing temperature on aging behavior
for HEATBOSS ® EPDM 3

| | Aging | Curing temperature (° F.) | | | |
|---|---|---|---|---|---|
| Mechanical properties | time (h) | 320 | 330 | 340 | 350 |
| ε_{b} (%) | 0 | 470 | 480 | 527 | 630 |
| ε_{b} retention (%) | 0 | 100 | 100 | 100 | 100 |
| | 72 | 98 | | 94.7 | |
| | 264 | 64 | 80 | 80.1 | 63 |
| | 504 | 34 | 43 | 53 | 35 |
| | 672 | | | 47 | |
| σᵤ (MPa) | 0 | 9.5 | 10.1 | 10.8 | 12.6 |
| σᵤ retention (%) | 0 | 100 | 100 | 100 | 100 |
| | 72 | | | 94.1 | |
| | 264 | 88 | 100 | 102.5 | 82 |
| | 504 | 58 | 80 | 82.3 | 58 |
| | 672 | | | 70 | |
| Shore A Hardness | 0 | 60 | 61 | 61 | 57 |
| | 72 | | | 0 | |
| Δ Hardness | 264 | 10 | 8 | 5 | 14 |
| | 504 | 9 | 8 | 6 | 12 |
| | 672 | | | 7 | |
| Compression set (%) | 0 | 20.8 | 20.1 | 20.1 | 19.2 |
| Tₛ (N/mm) | 0 | 28.2 | 29.2 | 29.2 | 28.7 |

Another advantage of HEATBOSS® EPDM 3 is its lower cost compared to silicone. HEATBOSS® EPDM 3 is only 60-70% the cost of the silicone for the similar application.

Molding Trial of HEATBOSS® EPDM 3 in Muffler Hanger to Compare with Conventional EPDM and Silicone

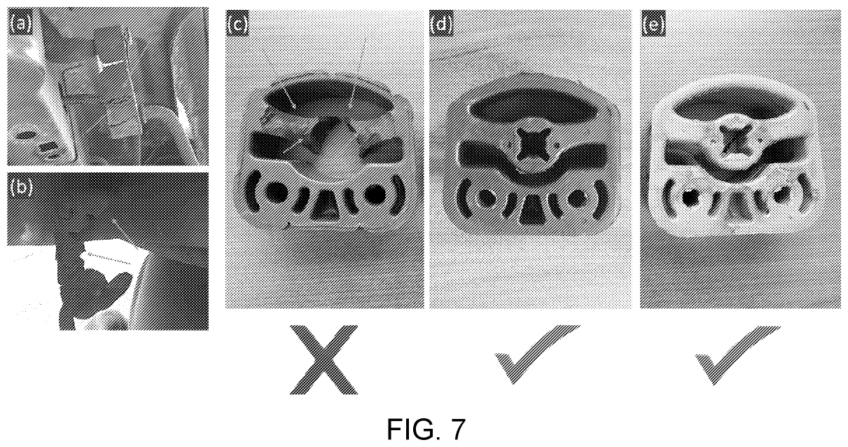

It has been seen that HEATBOSS® EPDM 3 offers extremely high heat resistance which enables it to be used in modern engine's design where durable rubber parts at high temperatures are required. One of these parts is a muffler hanger or exhaust hanger which is also known as exhaust support. The muffler hanger secures exhaust-related parts to the chassis and prevents the exhaust pipe from being damaged from bouncing gravels from road. Muffler hangers are usually made of flexible rubbers, such as silicone, to allow the exhaust to move as the vehicle travels and to absorb vibrations from road shocks along with noise dampening to provide a more comfortable cabin. As the vehicle travels and hits bumps in the road, the exhaust pipe moves up and down, this vibration cause muffler hangers to wear down over time, dry out, crack (FIG. 7a), and break over time or fail (FIG. 7b).

HEATBOSS® EPDM 3 was capable of being molded in the same way as silicone. The results showed that the muffler hanger based on CC2 fails under the test condition (FIG. 7c), while the HEATBOSS® EPDM 3-base (FIG. 7d) and silicone-base (FIG. 7e) ones pass the test successfully. The results once again confirm that HEATBOSS® EPDM 3 can be easily processed and its performance is comparable to that of silicone.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

1. A rubber composition comprising:
an ethylene-propylene-diene base terpolymer (EPDM);
wherein the rubber composition retains at least 35% of elongation at break and/or at least 55% tensile strength after heat aging at 350° F. for 504 hours.

2. The rubber composition of claim 1, wherein a diene of the EPDM is selected from the group consisting of 5-vinylidene-2-norbornene (VNB), 5-methylene-2-norbornene (MNB), 5-ethylidene-2-norbornene (ENB), 5-butyl-2-norbornene (BNB), 5-Crotyl-2-norbornene (CrNB), 5-Methallyl-2-norbornene (MANB), 5-isopropylidene-2-norbornene (IPNB), 5-Methyl-5-vinyl-2-norbornene (MeVNB), 5-Propenyl-2-norbornene (PNB), and a combination of any two or more thereof.

3-11. (canceled)

12. The rubber composition of claim 2, further comprising an oil.

13. The rubber composition of claim 12, wherein the oil is selected from the group consisting of a paraffinic oil, a naphthenic oil, and a combination thereof.

14-16. (canceled)

17. The rubber composition of claim 2, further comprising a zinc salt internal lubricant.

18. The rubber composition of claim 17, wherein the zinc salt internal lubricant is present in the rubber composition in an amount of about 5 to about 30 phr.

19. (canceled)

20. The rubber composition of claim 2, further comprising at least one filler selected from the group consisting of carbon black, calcium carbonate, silica, clay, magnesium carbonate, magnesium silicate, mica, talc, graphite, and wollastonite.

21. The rubber composition of claim 20, wherein the carbon black is present in an amount of about 10 to about 100 phr.

22-24. (canceled)

25. The rubber composition of claim 2, further comprising a wax.

26. The rubber composition of claim 25, wherein the wax is present in the rubber composition in an amount of about 1 to about 20 phr.

27. (canceled)

28. The rubber composition of claim 25, wherein the wax comprises a paraffinic wax and/or a low molecular weight polyethylene.

29-32. (canceled)

33. The rubber composition of claim 2, further comprising a coagent.

34. The rubber composition of claim 33, wherein the coagent is present in the rubber composition in an amount of about 1 to about 20 phr.

35-41. (canceled)

42. The rubber composition of claim 2, further comprising an antioxidant.

43. The rubber composition of claim 42, wherein the antioxidant is present in the rubber composition in an amount of about 1 to about 10 phr.

44-47. (canceled)

48. The rubber composition of claim 2, further comprising methyl-2-mercaptobenzimidazole (MMBI), zinc-2-methylmethylmercaptobenzimidazole (ZMMBI), or a combination thereof.

49. (canceled)

50. The rubber composition of claim 2, further comprising zinc oxide.

51. The rubber composition of claim 50, wherein the zinc oxide is present in the rubber composition in an amount of about 5 to about 25 phr.

52. (canceled)

53. A rubber composition comprising:
EPDM;
about 30 to about 50 phr of a paraffinic oil with a molecular weight in a range of from 390 g/mol to 800 g/mol;
about 5 to about 30 phr of a zinc salt internal lubricant
about 20 to about 50 phr of a N550 type carbon black and about 15 to about 25 phr of a N700 carbon black;
a wax;
a coagent;
about 5 to about 25 phr of zinc oxide;
peroxide; and
about 1 to about 5 phr ZMTI and about 0.5 to about 4 phr TMQ.

54-61. (canceled)

62. A process for forming an article comprising a rubber composition, the process comprising:
curing a curable composition comprising EPDM and a peroxide curing agent;
wherein the rubber composition retains at least 30% of elongation at break and/or at least 70% tensile strength after heat aging at 350° F. for 504 hours.

63-64. (canceled)
